(19) United States
(12) Patent Application Publication
(10) Pub. No.: US 2014/0356089 A1
(43) Pub. Date: Dec. 4, 2014

(54) MACHINING APPARATUS

(71) Applicant: Furmanite Australia Pty. Ltd., Port Melbourne (AU)

(72) Inventors: Anthony Backhouse, Port Melbourne (AU); Peter Casey, The Woodslands, TX (US); Douglas Schaffer, Port Melbourne (AU)

(73) Assignee: Furmanite Australia Pty. Ltd., Port Melbourne (AU)

(21) Appl. No.: 14/365,871

(22) PCT Filed: Dec. 14, 2012
(86) PCT No.: PCT/AU2012/001541

§ 371 Date: Jun. 16, 2014

(30) Foreign Application Priority Data
Dec. 15, 2011 (AU) 2011-905441
Dec. 15, 2011 (NZ) 597145

(51) Int. Cl. B23Q 9/00; B23Q 1/64; B23Q 17/22

(52) U.S. Cl. CPC B23Q 9/0014; B23Q 17/22; B23Q 1/64
USPC 409/186; 409/190

(57) ABSTRACT

There is disclosed apparatus for machining a workpiece, the apparatus including: a support; a boom mounted to the support; a machining station mounted to the boom; and displacement means provided on the boom for moving the boom relative to the support through engagement with a support surface. The support includes a boom pivot about which the boom is rotatable, the machining station being mounted on the boom remote from the boom pivot. The displacement means includes wheels or rollers having an axis of rotation extending along a radius from the boom pivot. The wheels or rollers have an at least partly tapered contact surface and have a diameter which increases along the axis of rotation away from the boom pivot.

### TECHNICAL FIELD

This invention relates to the field of large scale machining, especially but not only of metal, and in particular it relates to apparatus for the precision machining of such circular workpieces as draglines, pressure vessels and slew ring mounting faces and of non-circular workpieces such as turbine casings.

### BACKGROUND

In the past it has been proposed to machine the edges of large circular workpieces such as draglines with a machine head mounted on the end of a pivoted boom. Rotation of the boom allows the machine head to machine the circular flange or end face of the dragline. Setting of the machine head relative to the surface to be machined has generally been achieved by guiding the free end of the boom along a precision clocked track adjacent the work surface. These arrangements have been inconvenient in that clocking of the track is difficult and time-consuming particularly as the work surface may be several meters in diameter. Similar considerations apply to the machining of workpieces using a machining head which is mounted for displacement along a boom which is itself displaceable perpendicularly to the machining head. It is vital that the rails or other structure on which the machining head and boom are respectively displaceable are level and this is a particularly difficult and time consuming task. The tolerances which have been achievable with these arrangements are not acceptable for many machining operations.

One proposal for machining large circular workpieces is described in our U.S. Pat. No. 5,044,844, which is hereby incorporated in its entirety by reference. In this proposal, there is provided an apparatus which comprises a boom supported on a support structure. A machining station is mounted on the boom and a plurality of spaced displacement means are provided on the boom for enabling displacement of the boom relative to the support structure through engagement with one or more support surfaces. The displacement means are associated with respective portions of the boom and are each independently adjustable to allow the associated portion of the boom to move towards or away from the support surface.

The independent adjustment of each displacement means in U.S. Pat. No. 5,044,844 is controlled by a respective sensor monitoring movement of the associated portion of the boom relative to a reference to counter inconsistencies in the support surface and thereby to maintain the machining station at a desired level. The reference may be provided by a laser source which sweeps out a reference plane detectable by the respective sensors. Alternatively, the displacement of the boom may be mechanically monitored by the plurality of sensors each comprising a displacement transducer which engages a leveled template (sometimes known in relation to machining of circular workpieces as a datum ring).

An improvement to the above apparatus is disclosed in our U.S. Pat. No. 5,240,359, the contents of which are hereby incorporated by reference in their entirety. The apparatus of U.S. Pat. No. 5,240,359 includes at least three independent adjustment means for independently adjusting associated portions of the machining station towards or away from the support surface.

In each of the above apparatus, the machining station is transported by displacement means in the form of wheels or rollers. The wheels are of cylindrical form with their rolling surfaces sitting square with the support surface. If a circular workpiece is being machined, the machining station moves in a circular path about a central post of the support structure. Because the machining station is rolling in a circle, the inner diameter of the wheel rolling face consequently has to travel a shorter distance than the outer diameter. This results in “squirming”, or loss of traction, of the wheels. One way of reducing squirming is to mount the wheels as rigidly as possible with minimum clearances in the pivoting joints. However, this results in a tendency for the wheels to jump back as the holding force overcomes the tendency to squirm. This in turn has an adverse effect on the finish of the machined surface due to the jerky movement.

Another problem which arises in relation to the apparatus of U.S. Pat. No. 5,044,844 or U.S. Pat. No. 5,240,359 is in accurately providing feedback to the machine operator regarding the depth of the cut. One technique used to determine the depth of cut applied when feeding the milling cutter of the machining station into the surface of the job is, to use a dial indicator, which is fitted and zeroed whenever the desired cut depth changes. The dial indicator cannot be left in place on the apparatus because vibration during operation causes the dial indicator to fail after a few hours of use.

A further problem in connection with the above apparatus is that a safety issue exists if the milling cutter digs in to the workpiece such that the rotating milling cutter, rather than the wheel drive which is travelling at much lower speed, becomes the main motive mechanism for the boom. This can result in the boom running into the operator. One solution to this problem is to attach a trailing wheel and an encoder to the moving assembly of mill box, milling cutter and boom. In this arrangement, rotation of the trailing wheel above a predetermined speed is detected by the encoder, which in turn trips a circuit to shut down power to the apparatus. However, the present inventors have found that this system requires careful setup to ensure it works correctly.

It would be desirable to overcome or alleviate one or more of the above difficulties, or at least to provide a useful alternative.

### SUMMARY OF THE INVENTION

In a first aspect, the invention provides apparatus for machining a workpiece, the apparatus—including:
a support;
a boom mounted to the support;
a machining station mounted to the boom; and
displacement means provided on the boom for moving the boom relative to the support through engagement with a support surface;
wherein the support includes a boom pivot about which the boom is rotatable, the machining station being mounted on the boom remote from the boom pivot;
wherein the displacement means includes wheels or rollers having an axis of rotation extending along a radius from the boom pivot; and
wherein the wheels or rollers have an at least partly tapered contact surface and have a diameter which increases along the axis of rotation away from the boom pivot.

The wheels or rollers may have a taper angle such that their rolling radius corresponds to a predetermined desired radius. The predetermined desired radius may be substantially equal to the radius of the workpiece.

In a second aspect of the invention, there is provided apparatus for machining a workpiece, the apparatus including:
a support;
a boom mounted to the support;
a machining station mounted to the boom; and
displacement means provided on the boom for moving the boom relative to the support through engagement with a support surface;
wherein the machining station includes a machine head which is movable to engage the workpiece; and wherein the machine head is coupled to a digital depth gauge, the digital depth gauge being configured to measure a cutting depth of the machine head when the machine head engages with a surface of the workpiece.

In a third aspect, the invention provides an apparatus for machining a workpiece, the apparatus including:
a support;
a boom mounted to the support;
a machining station mounted to the boom; and
displacement means provided on the boom for moving the boom relative to the support through engagement with a support surface;
wherein a motion detector is provided on the machining station to measure an acceleration of the machining station, the motion detector being operably coupled to a drive of the apparatus, and wherein the motion detector is configured to shut down the drive if the measured acceleration is greater than a predetermined threshold.

The motion detector may include an accelerometer or a gyroscope.

In a fourth aspect, the invention provides an apparatus for machining a workpiece, the apparatus including:
a support;
a boom mounted to the support;
a machining station mounted to the boom; and
displacement means provided on the boom for moving the boom relative to the support through engagement with a support surface;
wherein the support includes a boom pivot about which the boom is rotatable, the machining station being mounted on the boom remote from the boom pivot, and
wherein the machining station includes a first module which is mounted on the boom, and a second module which is mountable to the first module at a plurality of positions, such that the apparatus is configurable to machine different locations on the workpiece without repositioning the first module relative to the boom.

Preferably, the first module carries the displacement means. Preferably, the second module is coupled to a machine head of the machining station.

The apparatus may include a position adjustment system for varying the position of the second module relative to the first module. The position adjustment system may include a series of spacers of varying lengths, the spacers being interchangeable and/or combinable to adjust the height of the second module relative to the first module. The position adjustment system may include brackets having elongate slots or recesses, the second module being fastenable to the first module via the elongate slots or recesses.

The second module may advantageously be dimensioned to pass through an opening in the first module, such that the vertical position of the second module relative to the first module can be adjusted through a range of positive and negative values relative to a zero position in which the second module is aligned with the boom, without changing the relative horizontal position of the second module.

In one embodiment, the position adjustment system includes a plurality of spaced through-holes in the first module to receive fasteners, thereby to mount the second module and/or the spacers to the first module.

In some embodiments, the displacement means are associated with respective portions of the boom and are each independently adjustable to allow the associated portion of the boom to move towards or away from the support surface. The independent adjustment of each displacement means in such embodiments is controlled by a respective sensor monitoring movement of the associated portion of the boom relative to a reference to counter inconsistencies in the support surface and thereby to maintain the machining station at a desired level.

In embodiments where a first module carries the displacement means and a second module is coupled to a machine head of the machining station, the position of the machine head can be advantageously be moved to machine at different heights along a workpiece, without needing to change the vertical positions of the displacement means.

In one embodiment in which the apparatus is for machining a circular workpiece, the boom is rotatable about a pivot support within the workpiece and the machining station, such as a milling head, is mounted on the boom remote from the pivot. Two angularly spaced displacement means are provided, each associated with a respective side of the boom. The support surface is conveniently, but not necessarily, the surface of the workpiece to be machined.

The reference against which displacement of the boom is monitored may comprise a precise beam such as may be emitted by a laser source in a plane which intersects with each of the sensors in use. The source of the beam may be centred on the pivot support in the rotating boom embodiment or be offset to one side of the workpiece. The beam may spread over the desired plane but more conveniently a beam from a scanning laser source continuously sweeps the desired plane at a speed which effectively gives continuous sweeping of the reference plane. Each sensor may comprise a series of diodes.

Alternatively, the displacement of the boom may be mechanically monitored by the plurality of sensors each comprising a displacement transducer which engages a leveled template. The template reference is especially, but not only, suitable for use with the rotating boom embodiment in which case it may comprise a setting point such as a beam pivoting off the pivot support but independently of the boom. However a convenient template for the rotating boom embodiment comprises an annular reference surface extending around the pivot support to allow the displacement transducers to engage successive sectors of the template as the boom rotates. The load imposed on a template by a displacement transducer will normally be very low so that a relatively lightweight and potentially easily levellable template may be used. Such a template may comprise a precision laid annular track of the type which may be supported on the workpiece, but advantageously the template is a rigid machined ring which may be of considerably smaller diameter than the workpiece and be supported independently of the workpiece.

The rigid template may be integral with the pivot support or, more conveniently independently levellable, for instance with three or even up to 64 supporting jacks, depending on the size of the template. The level may be determined by a clocking arm or other suitable device such as a spirit level.

### BRIEF DESCRIPTION OF THE DRAWINGS

Particular embodiments of the invention will now be described, by way of non-limiting example only, with reference to the accompanying drawings in which:

FIG. 1 is a schematic block digram of a, machining apparatus according to at least some embodiments of the invention;

FIGS. 2(a) to 2(c) are front projection views of three examples of tapered wheels usable with the apparatus of FIG. 1;

FIG. 3 is a side projection view of another example of a machining apparatus, in a first configuration in use with a workpiece;

FIG. 4 is a front projection view of the apparatus of FIG. 3;

FIG. 5 is a perspective view of the apparatus in a second configuration;

FIG. 6 is a side projection view of the apparatus in the second configuration; and

FIG. 7 is a side projection view of the apparatus in a third configuration.

### DETAILED DESCRIPTION

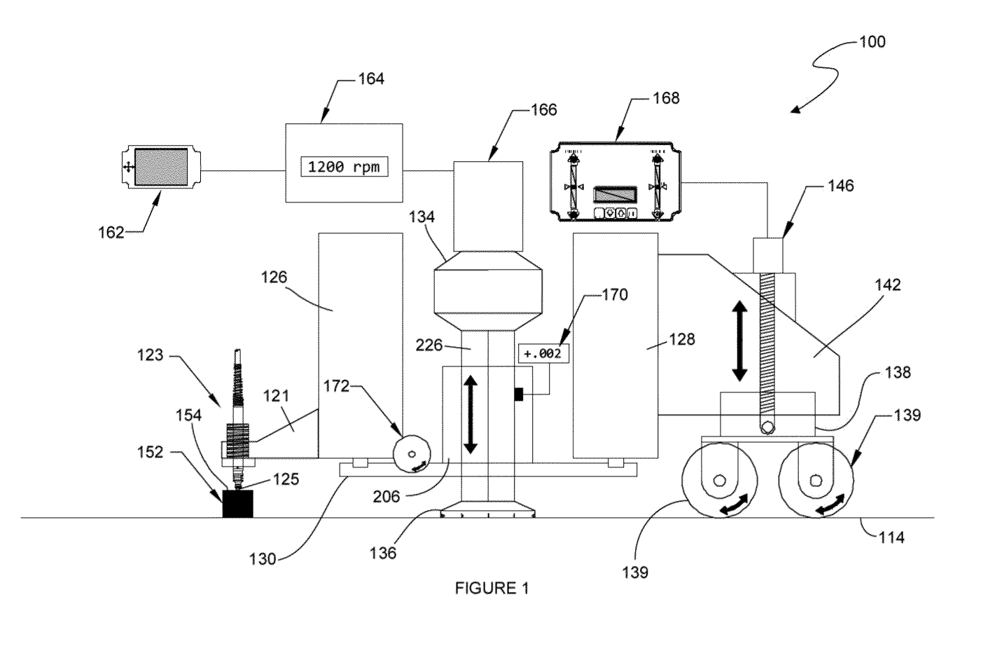

Referring initially to FIG. 1, there is shown a block diagram of an improved machining apparatus 100 according to an embodiment of the present invention. The machining apparatus 100 may be positioned within a circular workpiece such as a slew ring having a top edge or flange defining a work surface 114 to be machined, as will later be described.

The machining apparatus 100 includes a support (for example a pivot post, omitted for clarity) to which a boom is mounted. Mounted to the boom at the end of the boom distal to the support is a machining station having side-arms 126, 128. The machining station includes a milling machine 134 with a machine head (cutting head) 136, which is driven by an electric motor 166. The side-arms 126, 128 are positioned either side of the support. A cross-brace 130 extends between the side-arms 126, 128 to provide torsional rigidity. More than one cross-brace may be attached between the side-arms 126, 128 along their length.

The apparatus 100 includes displacement means in the form of a wheel unit 138 which is mounted to side-arm 128 on a bracket 142 through an actuator 146. The wheel unit 138 includes wheels 139 which ride over the work surface 114 (or a support surface) during operation of the apparatus 100. Although only one wheel unit 138 is shown in FIG. 1, a second wheel unit will generally be mounted to the side-arm 126 such that the boom is supported at three points—the support (pivot post) and the two angularly spaced wheel units disposed on opposite sides of the boom to form a triangular arrangement with the milling machine 134 disposed centrally of the wheel units.

The milling cutter machine 134 is shown located with its head 136 downwardly disposed to enable it to engage the work surface 114. However, the head 136 may be disposed at a variety of angles relative to the work surface, including facing upwards so as to machine an underneath surface of a workpiece, for example. The milling machine 134 is mounted to the machining station via a housing 206. A quill 226 is supported within and axially adjustable through the housing 206 in the direction indicated by the double-headed arrow to enable the height of the machine 134 to be adjusted relative to the boom in similar manner to that described in U.S. Pat. No. 5,240,359. The milling machine 134 may be adjusted in the radial direction (i.e. towards or away from the pivot) on linear rails (not shown).

The actuator 146 associated with each wheel unit 138 is adapted to permit raising and lowering of the wheel unit 138 relative to the bracket 142, thereby enabling the level of the associated side of the boom to be raised and lowered relative to the level of the portion of the work surface 114 on which the wheel unit 138 is riding at any one time. Each actuator is independently actuatable, so that the actuators provide the ability to keep the boom and machining station at a desired level notwithstanding that the surface configuration of the work surface 114 upon which the wheel units 138 ride may vary with lumps, including weld beads, and depressions. A control mechanism for monitoring such irregularities in the height of the machining station relative to the work surface and adjusting the actuators will be described below.

The wheel units 138 each have two pairs of aligned wheels 139 within, the pairs being mounted in an angled arrangement such that the axis of each is on a respective radius from the support. At least one wheel unit 138 is driven to displace the boom and machining station (including milling machine 134) about the pivot post.

A template 152, in the form of a rigid cylindrical ring (datum ring), extends coaxially about the support (pivot post). The template has an upper surface 154 which is precision ground to a tolerance of 0.01 mm. The template defines the reference level relative to which the apparatus 100 machines and it is therefore vital that the upper surface is at the desired orientation, normally perpendicular to the axis of the pivot post. A clocking arm 121 is provided to assist this and is rotatable about the pivot post with a gauge (probe) 123 having a sensing element 125 in contact with the surface 154 to determine deviation from the desired plane. The template may of course be inclined to the perpendicular to the pivot post axis and/or may define a non-planar reference surface if this is the configuration required for the machined work surface 114. If the template is not self-supporting a multitude of jacking screws should be used which hold the template and can be set according to the clocking arm to give the desired reference level.

In use, the correctly oriented template is sensed by a pair of displacement transducers 123 which may operate in conjunction with control box 168 to independently adjust the position of the wheel units 138 via screw jacks 146. The transducer elements are mounted on respective side-arms 126, 128 and are directed downwardly into contact with the surface 154. The transducers each serve to monitor variation between the template surface 154 and the level of the respective side of the boom, i.e. the side-arm 126 or 128. If variation is detected, as would occur if a wheel unit rode up onto a bump on the work surface 114, the corresponding transducer extends or retracts correspondingly and the control box 168 actuates the appropriate screw jack 146 to raise or lower the associated wheel unit 138 relative to its arm. Alternatively, screw jacks 146 may be replaced by hydraulic actuators, substantially as described in U.S. Pat. No. 5,044,844.

Alternatively to a datum ring 152, the reference level may comprise a precise beam such as may be emitted by a laser source in a plane which intersects with sensors mounted near the wheel units 138, 140. The source of the beam may be centred on the boom pivot. The beam may spread over the desired plane but more conveniently a beam from a scanning laser source, such as those manufactured by Hamar Laser Instruments, Inc, continuously sweeps the desired plane at a speed which effectively gives continuous sweeping of the reference plane. Each sensor may comprise an array of overlapping diodes capable of “seeing” the laser beam and of generating an electrical signal in response. The array of diodes is elongate and inclined slightly relative to the reference plane with a central diode arranged to give a zero response. With increasing distance from the central diode, both above and below, the diodes will give an increasing response to indicate the increased deviation from the norm. End diodes may be arranged to broaden the range of the sensors.

The wheels 139 of wheel unit 138 are machined to a slight taper such that the inside edge diameter (i.e., the diameter at the edge which is closest to the pivot post) is smaller than the outside edge diameter. This considerably relieves or eliminates the squirming problem associated with previously used arrangements and results in a superior surface finish.

The taper can be set for the wheel to roll in a true circle, typical for the size of the mill. Alternatively, the taper of the wheel can be machined to suit the diameter of a particular job. Advantageously, this substantially eliminates the tendency to squirm, thus providing a superior finish.

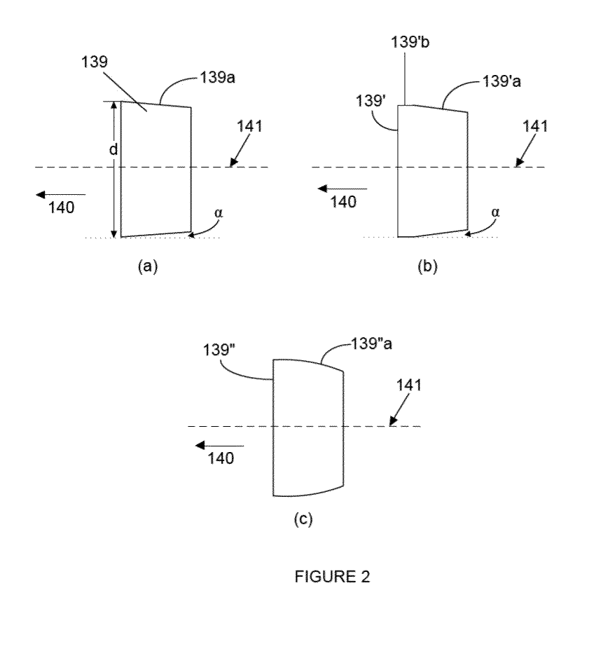

A substantially cylindrical wheel can be machined with a taper in various ways, examples being depicted in FIGS. 2(a) to 2(c). In FIG. 2(a) the wheel 139, having an axis of rotation 141, is fully tapered such that its diameter increases continuously from its inside edge to its outside edge along the axis of rotation 141 away from the boom pivot, i.e. in the direction of arrow 141. The wheel 139 has a contact surface 139a which is machined with a taper angle α, the angle being shown greatly exaggerated in the Figure. Alternatively, as shown in FIG. 2(b), a wheel 139′ may be machined with a partial taper, i.e. with a tapered contact surface 139′a having taper angle α, and an untapered portion 139′b. As shown in FIG. 2(c), it is also possible to machine a wheel 139″ with a curved and tapered surface 139″a, though this may be less effective than the configurations shown in FIGS. 2(a) and 2(b) when the wheel 139″ is used to drive the apparatus 100, due to the reduced contact area between the wheel 139″ and the surface on which it rolls.

The appropriate taper angle α may be calculated by treating the wheel 139 as a truncated cone which, if extended to a full cone, would have a height corresponding to the desired radius of travel of the wheel unit 138 about the boom pivot. This is because the radius of the natural rolling motion of the tapered wheel (when unconstrained by mounting to the boom), referred to herein as the rolling radius, would result in substantially the same circular path as the natural rolling motion of a cone. The taper angle α would thus be α=arc tan(d/2R), where d is the outside edge diameter of the wheel 139 (FIG. 2(a)) and R is the desired radius.

The desired radius may be either a typical expected radius of a circular workpiece (for example, 2 m) the surface of which the wheels 139 are to travel over, or the actual radius of a particular workpiece. Alternatively, if the wheels 139 are not mounted near the end of the boom distal to the pivot and are to travel over a support surface at a radius which is smaller than the radius at which machining is to be carried out, then the taper angle α should be set according to the smaller radius.

The apparatus 100 may include a digital scale 170 for determining the depth of cut applied to the work surface 114. The digital scale 170 has a body (not shown) attached to the quill housing 206, and a sliding saddle with readout attached to the sliding quill 226.

Advantageously, the digital scale 170 includes few moving parts, and so is not susceptible to damage caused by vibration of the apparatus 100 during use, by way of contrast with dial indicators which tend to become unusable quite quickly due to vibrational damage.

The milling machine 134 may be hydraulically driven, but it has been found advantageous to incorporate into the apparatus 100 a variable frequency drive (VFD) 164 which drives an electric motor 166 coupled to the milling machine 134. The VFD 164 may include a display to provide a readout of rotational speed, torque and/or current. The VFD includes a circuit which is in communication with an E-stop module 162 mounted to the machining station adjacent the milling machine 134. For example, E-stop module 162 may include a magnetic base by means of which the module 162 can be attached to one of the side-arms 126 or 128.

E-stop module 162 includes an accelerometer which measures acceleration of the boom, and associated control circuitry in communication with one or more outputs of the accelerometer. If the associated control circuitry detects acceleration of the machining station beyond predetermined operational limits, the control circuitry sends a signal to the VFD 164 to switch motor 166 off. The accelerometer may be an ADIS 16003 dual-axis accelerometer manufactured by Analog Devices, Inc. The accelerometer may have a data output coupled to a PIC16F688 microcontroller manufactured by Microchip Technology Inc, such that acceleration data can be transmitted to the microcontroller to compare against a preset acceleration threshold for safe operation of the apparatus 100.

The accelerometer of E-stop module 162 may be replaced with other types of motion detector, for example a gyroscopic integrated circuit or the like.

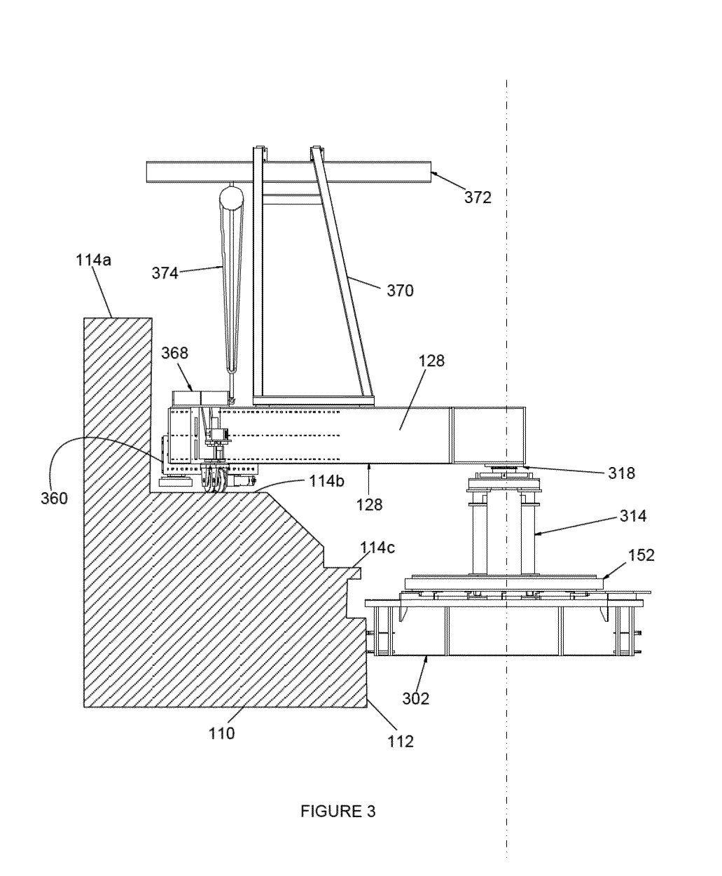

Turning now to FIGS. 3 to 7, a further variant 300 of the apparatus 100 is shown. Like reference numerals in FIGS. 3 to 7 and FIG. 1 denote like parts.

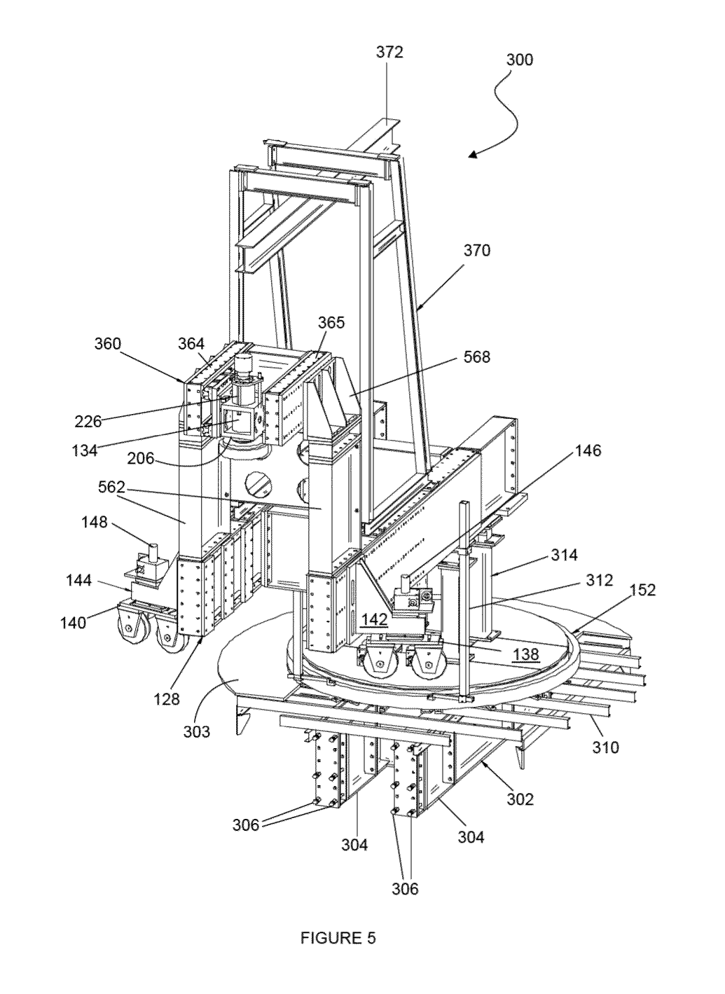

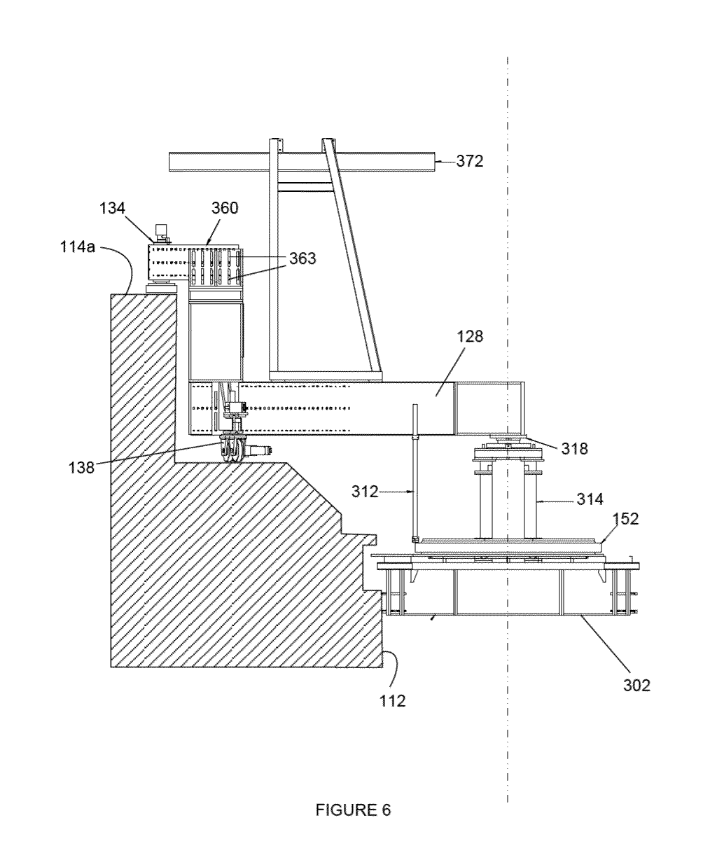

Referring to FIG. 5, apparatus 300 includes a support including a spider base 302 having a platform 303 and girders 304 extending across the interior of the workpiece 112 (FIG. 6) to locate a centre bearing 318 of the apparatus 300 at the centre of the circular workpiece 112. The girders 304 may be welded at their radially outer ends of the inner wall of the workpiece, but are conveniently located by screw threaded studs 306 which extend to rigidly engage the workpiece and which are adjustable to centralise the pivot support.

The centre bearing 318 is supported on centre support 314 which may be adjusted to suit the dimensions of the workpiece 112. Centre support 314 provides a rigid structure to elevate and support the centre of the apparatus 300. Centre support 314 may be provided with access points to allow for diameter measurements to be made through the centre support.

The centre bearing 318 is fixed in the vertical direction relative to the centre support 314 and the spider base 302. It may be adjusted in the X/Y directions to allow the bearing 318 to be centred relative to the workpiece 112. Centre bearing 318 is a point of rotation that can pitch and roll if needed. The centre bearing 318 is independent of the reference plane defined by datum ring 152 to allow for adjustments of the centre of the apparatus without affecting the reference plane required for the workpiece.

The apparatus 300 includes probe brackets 312 to retain the probe 123 (as shown in FIG. 1, but omitted from FIGS. 3 to 7 for clarity).

In the modified apparatus of FIGS. 3 to 7, the machining station now includes a first module including the side-arms 126, 128, and a second module in the form of an adjustable mill box 360 having opposed side-arms 364, 365 between which the milling machine 134 is mounted. The mounting may be permanent, for example by welding, but is typically by way of fasteners threaded through a plurality of through-holes formed in the side-arms 364, 365.

The second module 360 is mounted to the side-arms 126, 128 of the first module via spacers 362 and angle brackets 368. Spacers 362 are detachably mounted to the side-arms 126, 128 of the first module by threaded fasteners, angle brackets 368 mounted to the spacers, and the second module 360 is then mounted between the spacers by threaded fasteners which are passed through elongate slots 363 in the angle brackets 368. Elongate slots 363 provide means of adjusting the vertical position of the mill box 360.

The spacers 362 may be provided as a series of members of increasing predetermined length. Accordingly, a coarse adjustment of the height of the mill box 360 above or below the side-arms 126, 128 of the first module may be made by interchanging and/or combining the members of different lengths. In addition, the elongate slots 363 in brackets 368 provide a second, finer, level of height adjustment. Advantageously, this allows a single adjustable mill box 360 to be deployed at multiple heights across a workpiece, without requiring fabrication of a customised machining station for each job, and without the use of moving parts and associated control electronics.

Also provided in apparatus 300 is a travelling gantry 370 supporting a beam 372, extending the length of the side-arms 126, 128, and along which a chain block 374 (FIG. 5) is adapted to travel. This allows an operator of the apparatus 300 to relocate the mill box 360 and spacers 362 along the side-arms 126, 128 to move the milling machine 134 without requiring the use of separate heavy machinery such as a crane.

By relocating the second module (mill box) 360 without changing the first module or the boom, machining can be performed at various elevations and diameters, all from one common centre and reference plane, to provide repeatable machining of parallel and concentric surfaces. This is illustrated in FIGS. 3, 6 and 7; in which the apparatus 300 is shown in side view in three different machining positions. In the particular example shown, the apparatus 300 is mounted within a head of a hydroelectric turbine depicted in schematic cross-section at 110. However, it will be understood that the apparatus 300 may be used to machine, in a single working setup, any workpiece in which multiple surfaces located at different heights and/or diameters are to be machined.

The turbine 110 includes a discharge section 112 within which the apparatus 300 is mounted via spider base 302 as previously described. The centre support 314 is adjusted in height such that the wheel units 138, 140 may ride along the upper surface of the bottom ring 114b as the side-arms 126, 128 and mill box 360 rotate about centre bearing 318. Importantly, in the example described below, the side-arms 126, 128 of the first module carrying wheel units 138, 140 are not adjusted in position in order to machine different surfaces, and so the wheels of wheel units 138, 140 are always rolling on the same support surface.

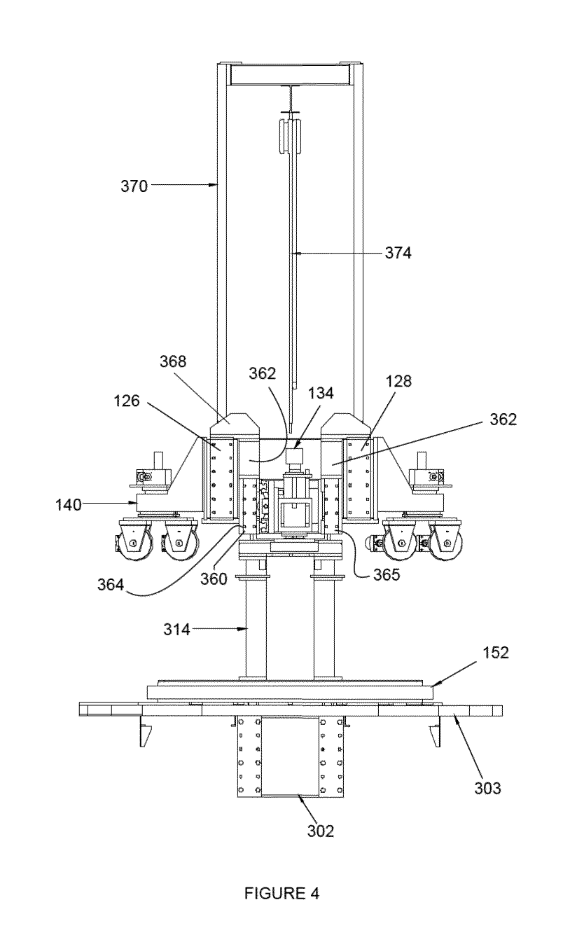

Typically, the surface on which the wheels are to roll is machined first so as to provide a smooth rolling surface for further machining, thereby minimising height adjustments which would be required if the wheels encountered bumps or other irregularities in the rolling surface. As shown in FIG. 3, machining of the bottom ring 114b is therefore undertaken first. In order to mount the mill box 360 to side-arms 126, 128 for this operation, angle brackets 368 are attached to the top surfaces of the side-arms 126, 128 and spacers 362 of appropriate length fastened to the angle brackets 368 between the side-arms 126, 128. Mill box 360, which as seen in FIG. 4 is dimensioned to pass through the gap between side-arms 126, 128, can then be fastened to the spacers 362. The milling head 136 may then be positioned (by fine adjustment of the quill 226) to machine the surface of bottom ring 114b. The operator then activates power to the apparatus 300 to machine the bottom ring 114b, with wheel units 138, 140 travelling along bottom ring 114b. The surface of the bottom ring 114b is machined in accordance with the reference plane defined by datum ring 152, substantially as described in U.S. Pat. Nos. 5,044,844 and 5,240,359.

Fine adjustment of the radial position of the milling machine 134 within mill box 360 may be achieved by moving the machine 134 along linear rails.

In order to machine the head cover flange 114a of the turbine, the machine operator attaches chain block 374 of travelling gantry 370 (FIG. 3) to the mill box 360 in order to reposition the mill box 360. Now spacers 562 are used to adjust the height of mill box 360 relative to the side-arms 126, 128 such that the milling machine 134 can be positioned near head cover flange 114a. The mill box 360 is mounted between angle brackets 568, with some further height adjustment able to be applied via elongate slots 563 in order to bring the milling head 136 within a predetermined (small) distance of the head cover flange 114a.

Note that the repositioning of the milling head 136 is achieved purely by interchanging the spacers 362 and 562, and does not require adjustment of the side-arms 126, 128, centre support 314, datum ring 152 etc. of the apparatus 300. The operator can then activate power to the apparatus 300 to machine the head cover flange 114a, with wheel units 138, 140 travelling along bottom ring 114b as before.

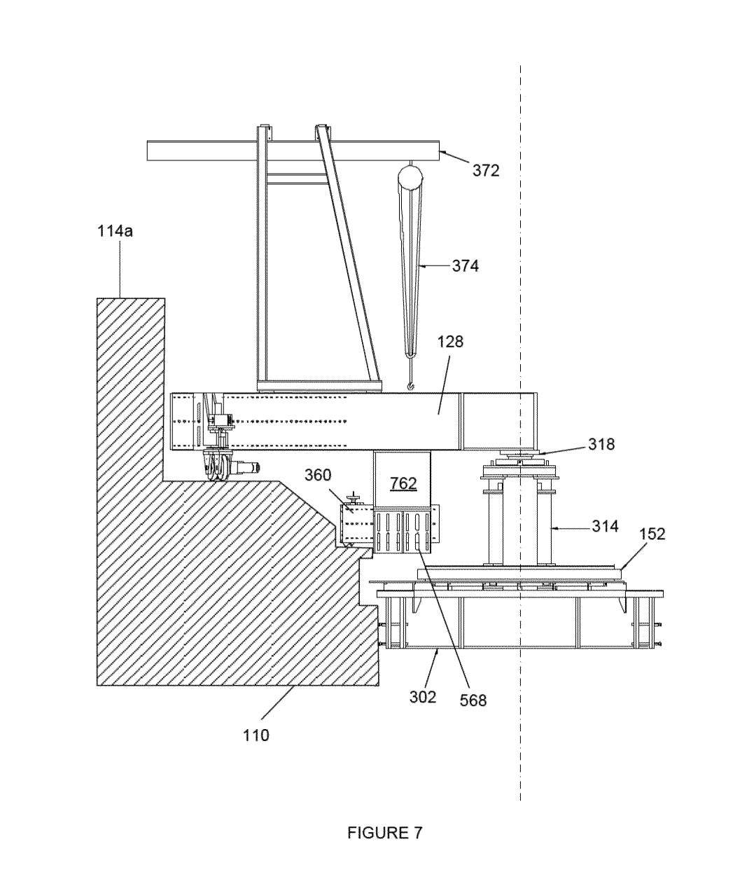

As shown in FIG. 7, the travelling gantry 370 and chain block 374 can again be used to reposition the mill box 360, this time to machine the discharge ring 114c. Spacers 762 having different length to spacers 362 and 562 are used, this time in inverted orientation to that shown in FIGS. 5 and 6, such that the mill box 360 can be positioned below the side-arms 126, 128.

The apparatus 300 conveniently provides means to simply adjust the position of the milling head 136 so as to be able to machine a variety of large fabrications without requiring adjustment via a mechanism which includes moving parts. The second module 360 and spacers 362, 562, 762 of fixed, predetermined dimensions can be fitted to the apparatus 300 without the use of heavy machinery. Further, in at least some embodiments, the second module 360 which carries the milling head 136 is separated from the first module which carries the displacement means and associated sensors for determining the position of the first module relative to the reference level.

Many modifications of the above embodiments will be apparent to the skilled person, without departing from the scope of the invention as defined by the claims appended hereto.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. Apparatus for machining a workpiece, the apparatus including:
a support;
a boom mounted to the support;
a machining station mounted to the boom; and
displacement means provided on the boom for moving the boom relative to the support through engagement with a support surface;
wherein the support includes a boom pivot about which the boom is rotatable, the machining station being mounted on the boom remote from the boom pivot;
wherein the displacement means includes wheels or rollers having an axis of rotation extending along a radius from the boom pivot; and
wherein the wheels or rollers have an at least partly tapered contact surface and have a diameter which increases along the axis of rotation away from the boom pivot.

2. Apparatus according to claim 1, wherein the wheels or rollers have a taper angle such that their rolling radius corresponds to a predetermined desired radius.

3. Apparatus according to claim 2, wherein the predetermined desired radius is substantially equal to the radius of the workpiece.

4. Apparatus for machining a workpiece, the apparatus including:
a support;
a boom mounted to the support;
a machining station mounted to the boom; and
displacement means provided on the boom for moving the boom relative to the support through engagement with a support surface;
wherein the machining station includes a machine head which is movable to engage the workpiece; and wherein the machine head is coupled to a digital depth gauge, the digital depth gauge being configured to measure a cutting depth of the machine head when the machine head engages with a surface of the workpiece.

5. Apparatus for machining a workpiece, the apparatus including:
a support;
a boom mounted to the support;
a machining station mounted to the boom; and
displacement means provided on the boom for moving the boom relative to the support through engagement with a support surface;
wherein a motion detector is provided on the machining station to measure an acceleration of the machining station, the motion detector being operably coupled to a drive of the apparatus, and wherein the motion detector is configured to shut down the drive if the measured acceleration is greater than a predetermined threshold.

6. Apparatus according to claim 5, wherein the motion detector includes an accelerometer or a gyroscope.

7. Apparatus for machining a workpiece, the apparatus including:
a support;
a boom mounted to the support;
a machining station mounted to the boom; and
displacement means provided on the boom for moving the boom relative to the support through engagement with a support surface;
wherein the support includes a boom pivot about which the boom is rotatable, the machining station being mounted on the boom remote from the boom pivot, and
wherein the machining station includes a first module which is mounted on the boom, and a second module which is mountable to the first module at a plurality of positions, such that the apparatus is configurable to machine different locations on the workpiece without repositioning the first module relative to the boom.

8. Apparatus according to claim 7, wherein the first module carries the displacement means.

9. Apparatus according to claim 7, wherein the second module is coupled to a machine head of the machining station.

10. Apparatus according to claim 7, including a position adjustment system for varying the position of the second module relative to the first module.

11. Apparatus according to claim 10, wherein the position adjustment system includes a series of spacers of varying lengths, the spacers being interchangeable and/or combinable to adjust the height of the second module.

12. Apparatus according to claim 10, wherein the position adjustment system includes brackets having elongate slots or recesses, the second module being fastenable to the brackets via the elongate slots or recesses.

13. Apparatus according to claim 10, wherein the position adjustment system includes a plurality of spaced through-holes in the first module to receive fasteners, thereby to mount the second module and/or the spacers to the first module.
